(19) United States
(12) Patent Application Publication
(10) Pub. No.: US 2011/0205166 A1
(43) Pub. Date: Aug. 25, 2011

(54) TOUCH PANEL

(76) Inventors: Kyoung Soo CHAE, Gyunggi-do (KR); Young Soo Oh, Gyunggi-do (KR); Jong Young Lee, Gyunggi-do (KR); Yun Ki Hong, Gyunggi-do (KR); Hee Bum Lee, Gyunggi-do (KR)

(21) Appl. No.: 12/773,736

(22) Filed: May 4, 2010

(30) Foreign Application Priority Data
Feb. 24, 2010 (KR) 10-2010-0016758

(51) Int. Cl. G06F 3/041

(52) U.S. Cl. 345/173

(57) ABSTRACT

Disclosed is a touch panel, which includes a transparent conductive film, electrodes printed at both ends of the transparent conductive film, and a substrate having a wiring connected to the electrodes and formed in a multilayer therein, and surrounding the transparent conductive film at the inner peripheral surface thereof, so that the use of the substrate having the wiring in multilayer form enables a plurality of wirings necessary for multi touch to be formed even under conditions of a thin bezel size, thus satisfying the trend which is reducing the size of electronic products.

### CROSS REFERENCE TO RELATED APPLICATION

This application claims the benefit of Korean Patent Application No. 10-2010-0016758, filed Feb. 24, 2010, entitled “Touch panel”, which is hereby incorporated by reference in its entirety into this application.

### BACKGROUND OF THE INVENTION

1. Technical Field

The present invention relates to a touch panel.

2. Description of the Related Art

Alongside the growth of computers using digital technology, devices assisting the computers have also been developed, and portable transmitters and other personal information processors execute processing of text and graphics using a variety of input devices such as a keyboard, mouse, digitizer and so on.

While the rapid advancement of the information-based society has been widening the use of computers more and more, there have been occurring the problems of it being difficult to efficiently operate products using only the keyboard and mouse as being responsible for the input device function as an interface. Thus, the demand for a device which is simple and infrequently operates erroneously and has the capability to input easily, in particular, enables information to be input by the hand of a user who is carrying it, is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD), a plasma display panel (PDP), an electroluminescence (El) element or the like, or a cathode ray tube (CRT), so that a user selects the information desired while viewing the image display device. Also, the touch panel is generally classifiable as resistive type, capacitive type, electromagnetic type, SAW type, and infrared type.

The type of touch panel selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. In particular, resistive and capacitive types are prevalently used.

In addition, in order to more efficiently utilize an application program operating with the touch panel, a need for multi touch ones in which a user may operate the device while bringing fingers of the user into contact with the panel is increasing. As such, multi touch simultaneously recognizes a plurality of touch points which are input to the touch panel, unlike single touch which recognizes only one touch point. However, in order to achieve multi touch techniques, the number of wirings of the touch panel is increased compared to the single touch kind, and thus the width of the bezel of the touch panel is increased, undesirably making it difficult to reduce the size of electronic products.

### SUMMARY OF THE INVENTION

Accordingly, the present invention has been made keeping in mind the problems encountered in the related art and the present invention is intended to provide a touch panel which includes a substrate having a wiring formed in a multilayer thus ensuring the number of wirings necessary for multi touch without increasing the width of a bezel.

An aspect of the present invention provides a touch panel, including a transparent conductive film, electrodes printed at both ends of the transparent conductive film, and a substrate having a wiring connected to the electrodes and formed in a multilayer therein, and surrounding the transparent conductive film at the inner peripheral surface thereof.

In this aspect, when N electrodes are printed on the transparent conductive film, N wirings may be connected to the N electrodes and may be respectively multilayered in the substrate.

In this aspect, the touch panel may further include a connector formed at the outer side of the substrate and having a connection pattern extending from the wiring to thus be exposed.

In this aspect, the touch panel may further include a reinforcement plate formed on one surface of the substrate so as to protect the transparent conductive film.

Another aspect of the present invention provides a touch panel, including a first transparent conductive film, first electrodes printed at both ends of the first transparent conductive film, a first substrate having a first wiring connected to the first electrodes and formed in a multilayer therein, and surrounding the first transparent conductive film at the inner peripheral surface thereof, a second transparent conductive film, second electrodes printed at both ends of the second transparent conductive film, a second substrate having a second wiring connected to the second electrodes and formed in a multilayer therein, and surrounding the second transparent conductive film at the inner peripheral surface thereof, and an adhesive layer provided between one surface of the first substrate and one surface of the second substrate so as to adhere together the first substrate and the second substrate.

In this aspect, when N first electrodes are printed on the first transparent conductive film, N first wirings may be connected to the N first electrodes and may be respectively multilayered in the first substrate, and when M second electrodes are printed on the second transparent conductive film, M second wirings may be connected to the M second electrodes and may be respectively multilayered in the second substrate.

In this aspect, the touch panel may further include a first connector formed at the outer side of the first substrate and having a first connection pattern extending from the first wiring to thus be exposed, and a second connector formed at the outer side of the second substrate and having a second connection pattern extending from the second wiring to thus be exposed.

In this aspect, the touch panel may further include a first reinforcement plate formed on the other surface of the first substrate so as to protect the first transparent conductive film, and a second reinforcement plate formed on the other surface of the second substrate so as to protect the second transparent conductive film.

In this aspect, the second substrate may be disposed under the first substrate, and a dot spacer may be formed on one surface of the second transparent conductive film.

### BRIEF DESCRIPTION OF THE DRAWINGS

The features and advantages of the present invention will be more clearly understood from the following detailed description taken in conjunction with the accompanying drawings, in which:

FIG. 1 is an exploded perspective view showing a touch panel according to a first embodiment of the present invention;

FIG. 2 is a cross-sectional view taken along the line A-A′ of FIG. 1;

FIG. 3 is a cross-sectional view taken along the line B-B′ of FIG. 1; and

FIGS. 4 and 5 are exploded perspective views showing a touch panel according to a second embodiment of the present invention.

### DESCRIPTION OF SPECIFIC EMBODIMENTS

Hereinafter, embodiments of the present invention will be described in detail while referring to the accompanying drawings. Throughout the drawings, the same reference numerals are used to refer to the same or similar elements. In the description, the terms “first”, “second” and so on are used to distinguish one element from another element, and the elements are not defined by the above terms. Moreover, descriptions of known techniques, even if they are pertinent to the present invention, are regarded as unnecessary and may be omitted when they would make the characteristics of the invention and the description unclear.

Furthermore, the terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

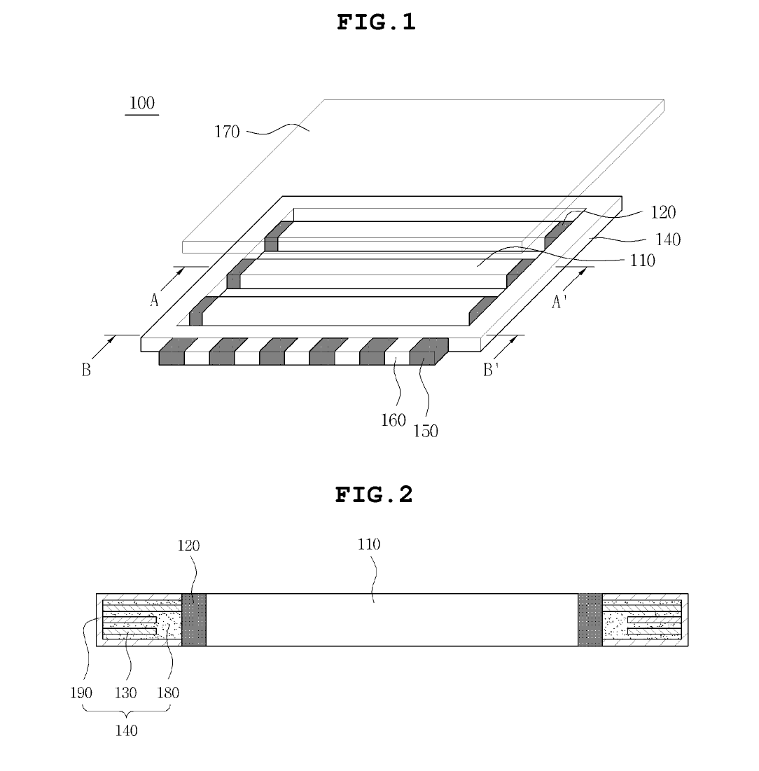

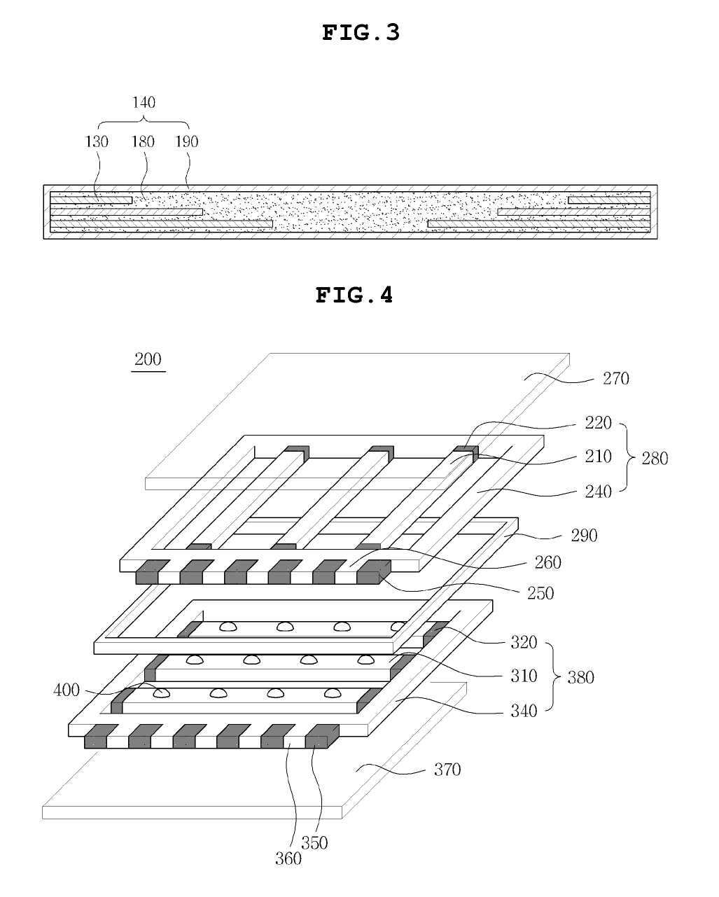

FIG. 1 is an exploded perspective view showing a touch panel according to a first embodiment of the present invention, FIG. 2 is a cross-sectional view taken along the line A-A′ of FIG. 1, and FIG. 3 is a cross-sectional view taken along the line B-B′ of FIG. 1.

As shown in FIGS. 1 to 3, the touch panel 100 according to the present embodiment includes a transparent conductive film 110, electrodes 120 printed at both ends of the transparent conductive film 110, and a substrate 140 having a wiring 130 connected to the electrodes 120 and formed in a multilayer therein and surrounding the transparent conductive film 110 at the inner peripheral surface thereof.

The transparent conductive film 110 functions to perceive external input so that corresponding coordinates are recognized by a controller. The material of the transparent conductive film 110 is not particularly limited, and may include a conductive polymer such as poly-3,4-ethylenedioxythiophene/polystyrenesulfonate (PEDOT/PSS), polyaniline, polyacetylene and polyphenylenevinylene, or indium tin oxide (ITO). Although the transparent conductive film 110 is illustrated in the form of a rod in the drawing, it may be formed in any type of pattern such as a lozenge shape, a hexagonal shape, an octagonal shape, or a triangular shape. When the transparent conductive film 110 is formed in any type of pattern in this way, the touch panel 100 according to the present embodiment may perform a multi touch function.

The electrodes 120 allow electrical signals to be input to or output from the transparent conductive film 110, and are printed at both ends of the transparent conductive film 110. The electrodes 120 may be made of silver (Ag) paste or organic Ag having superior electrical conductivity, but the present invention is not limited thereto. In addition, a conductive polymer material, carbon black (including carbon nanotubes), or a low resistive metal including metal or a metal oxide such as ITO may be used. Furthermore, the electrodes 120 are printed using silk screening, gravure printing, or ink-jet printing.

The substrate 140, which surrounds the transparent conductive film 110 at the inner peripheral surface thereof, functions to support the transparent conductive film 110. Herein, the substrate 140 includes the wiring 130 in multilayer form, an insulating layer 180, and a protective layer 190 for protecting the wiring 130 and the insulating layer 180, thus exhibiting superior mechanical strength to thereby ensure the structural stability of the touch panel 100. The kind of substrate 140 is not particularly limited, and a typical printed circuit board which is slim may be utilized, thus reducing the manufacturing cost of the touch panel 100 and simplifying the manufacturing process.

The wiring 130 is provided in the form of a multilayer in the substrate 140 and is connected to the electrodes 120. This wiring may be typically formed through a build-up process used for printed circuit boards. The number of wirings 130 formed may be the same as the number of electrodes 120, and the wirings 130 may be multilayered in the substrate 140. For example, as shown in FIGS. 1 to 3, in the case where a total of six electrodes 120 are printed on the transparent conductive film 110, six wirings 130 corresponding to the six electrodes 120 may be provided and the six wirings 130 may be three-layered in the substrate 140. Specifically, in the case where N electrodes 120 are printed on the transparent conductive film 110, N wirings 130 may be connected to the N electrodes 120 and may be respectively multilayered in the substrate 140. This is merely illustrative, and it goes without saying that wirings 130 more than two per layer are formed instead of a plurality of wirings 130 being respectively multilayered.

As mentioned above, the touch panel 100 according to the present embodiment is advantageous because the wiring 130 is provided in the form of a multilayer, thus reducing the width of a bezel which does not actually perform a touch function, thereby satisfying the trend which is reducing the size of electronic products.

Further, the touch panel 100 includes a connector 160 formed at the outer side of the substrate 140 so as to form a connection with a flexible printing cable. The connector 160 has a connection pattern 150 extending from the wiring 130 to thus be exposed, and the connection pattern 150 is finally connected to the flexible printing cable. Thus, electrical signals are input or output in the sequence of the transparent conductive film 110→the electrodes 120→the wiring 130→the connection pattern 150→the flexible printing cable.

Further, in order to protect the transparent conductive film 110, a reinforcement plate 170 is formed on one surface of the substrate. The material of the reinforcement plate 170 is not particularly limited, and may include polyethyleneterephthalate (PET), polycarbonate (PC), polymethylmethacrylate (PMMA), polyethylenenaphthalate (PEN), polyethersulfone (PES), cyclic olefin polymer (COC), triacetylcellulose (TAC) film, polyvinyl alcohol (PVA) film, polyimide (PI) film, polystyrene (PS), biaxially oriented polystyrene (BOPS; containing K resin), glass or reinforced glass and so on.

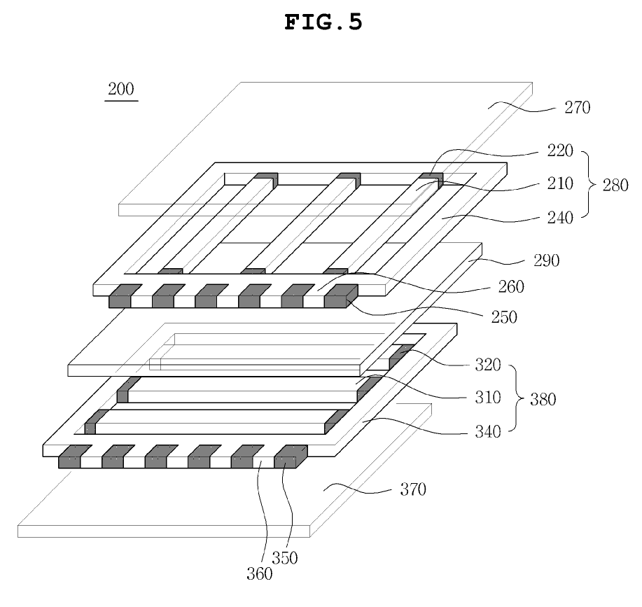

FIGS. 4 and 5 are exploded perspective views showing a touch panel according to a second embodiment of the present invention.

As shown in FIGS. 4 and 5, the touch panel 200 according to the present embodiment includes an upper panel 280 including a first transparent conductive film 210, first electrodes 220 and a first substrate 240, and a lower panel 380 including a second transparent conductive film 310, second electrodes 320 and a second substrate 340, and each of the upper panel 280 and the lower panel 380 is formed in the same configuration as the touch panel 100 according to the first embodiment. Specifically, the touch panel 200 according to the present embodiment is obtained by adhering two touch panels 100 according to the first embodiment by means of an adhesive layer 290. Thus, the description which overlaps with that of the first embodiment is omitted, and only additional contents are described.

The adhesive layer 290 functions to adhere the upper panel 280 and the lower panel 380 to each other. As shown in FIG. 4, an adhesive layer 290 having an opening may be used so that the first transparent conductive film 210 and the second transparent conductive film 310 are brought into contact with each other when a user presses the touch panel 200. In this case, the touch panel 200 is of the resistive type. Hence, it is desirable that dot spacers 400 be formed on one surface of the second transparent conductive film 310. The dot spacers 400 play a role in alleviating impact when bringing the first transparent conductive film 210 into contact with the second transparent conductive film 310, providing repulsive force to restore the first transparent conductive film 210 to its original position after elimination of the pressure of the user, and insulating the first transparent conductive film 210 from the second transparent conductive film 310 when the touch panel is not used.

Also, as shown in FIG. 5, an adhesive layer 290 having no opening may be used, and this touch panel 200 may be used as a capacitive type touch panel by insulating the first transparent conductive film 210 and the second transparent conductive film 310 from each other.

In order to efficiently recognize the X-axis coordinate and the Y-axis coordinate, the first transparent conductive film 210 and the second transparent conductive film 310 may be disposed perpendicular to each other (FIGS. 4 and 5). Also, a first connector 260 having a first connection pattern 250 and a second connector 360 having a second connection pattern 350 may be formed at the same position so as to easily form a connection with a flexible printing cable (FIGS. 4 and 5). This configuration is merely illustrative, and the touch panel 200 may be provided in various configurations depending on the function or use of the electronic product to which the touch panel is later mounted.

Further, in order to protect the first transparent conductive film 210 and the second transparent conductive film 310, the touch panel 200 according to the present embodiment may include a first reinforcement plate 270 on the other surface of the first substrate 240 (which is the surface opposite the surface having the adhesive layer 290), and a second reinforcement plate 370 on the other surface of the second substrate 340 (which is the surface opposite the surface having the adhesive layer 290).

As described hereinbefore, the present invention provides a touch panel. According to the present invention, the touch panel includes a substrate having a wiring formed in a multilayer, thus enabling a plurality of wirings necessary for multi touch to be formed even under conditions of a thin bezel size, thereby satisfying the trend which is reducing the size of an electronic product.

Also, according to the present invention, a typical printed circuit board is utilized as the substrate having the wiring in multilayer form, thus reducing the manufacturing cost of the touch panel and simplifying the manufacturing process.

Although the embodiments of the present invention regarding the touch panel have been disclosed for illustrative purposes, those skilled in the art will appreciate that a variety of different modifications, additions and substitutions are possible, without departing from the scope and spirit of the invention as disclosed in the accompanying claims. Accordingly, such modifications, additions and substitutions should also be understood as falling within the scope of the present invention.

What is claimed is:

1. A touch panel, comprising:
a transparent conductive film;
electrodes printed at both ends of the transparent conductive film; and
a substrate having a wiring connected to the electrodes and formed in a multilayer therein, and surrounding the transparent conductive film at an inner peripheral surface thereof.

2. The touch panel as set forth in claim 1, wherein when N electrodes are printed on the transparent conductive film, N wirings are connected to the N electrodes and are respectively multilayered in the substrate.

3. The touch panel as set forth in claim 1, further comprising a connector formed at an outer side of the substrate and having a connection pattern extending from the wiring to thus be exposed.

4. The touch panel as set forth in claim 1, further comprising a reinforcement plate formed on one surface of the substrate so as to protect the transparent conductive film.

5. A touch panel, comprising:
a first transparent conductive film;
first electrodes printed at both ends of the first transparent conductive film;
a first substrate having a first wiring connected to the first electrodes and formed in a multilayer therein, and surrounding the first transparent conductive film at an inner peripheral surface thereof;
a second transparent conductive film;
second electrodes printed at both ends of the second transparent conductive film;
a second substrate having a second wiring connected to the second electrodes and formed in a multilayer therein, and surrounding the second transparent conductive film at an inner peripheral surface thereof; and
an adhesive layer provided between one surface of the first substrate and one surface of the second substrate so as to adhere together the first substrate and the second substrate.

6. The touch panel as set forth in claim 5, wherein when N first electrodes are printed on the first transparent conductive film, N first wirings are connected to the N first electrodes and are respectively multilayered in the first substrate, and
when M second electrodes are printed on the second transparent conductive film, M second wirings are connected to the M second electrodes and are respectively multilayered in the second substrate.

7. The touch panel as set forth in claim 5, further comprising a first connector formed at an outer side of the first substrate and having a first connection pattern extending from the first wiring to thus be exposed; and
a second connector formed at an outer side of the second substrate and having a second connection pattern extending from the second wiring to thus be exposed.

8. The touch panel as set forth in claim 5, further comprising a first reinforcement plate formed on the other surface of the first substrate so as to protect the first transparent conductive film; and
a second reinforcement plate formed on the other surface of the second substrate so as to protect the second transparent conductive film.

9. The touch panel as set forth in claim 5, wherein the second substrate is disposed under the first substrate, and a dot spacer is formed on one surface of the second transparent conductive film.
